(19) United States
(12) Patent Application Publication
(10) Pub. No.: US 2011/0217447 A1
(43) Pub. Date: Sep. 8, 2011

(54) Packaged Protein-Enriched Food Product

(75) Inventors: Theodore R. Casey, Dallas, TX (US); Michael Casid, Plano, TX (US)

(73) Assignee: DYMATIZE ENTERPRISES, LLC, Farmers Branch, TX (US)

(21) Appl. No.: 13/108,884

(22) Filed: May 16, 2011

Related U.S. Application Data
(62) Division of application No. 11/866,284, filed on Oct. 2, 2007, now abandoned.

(51) Int. Cl. A23L 1/164; A23L 1/305; A23L 1/308

(52) U.S. Cl. 426/621

(57) ABSTRACT

A protein-enriched food product having enhanced texture characteristics combined with ease of use, a method of its manufacture and a method of its packaging is disclosed. The protein-enriched food product comprises a coarsely granulated mixture of cereal pieces combined with a finely granulated high-protein powder mixture. The cereal mixture has a moisture level between 2% and 20% by weight, and comprises a edible fiber material so that fiber content is between 2% and 20% by weight. The protein powder mixture has a moisture level between 2% and 15% by weight, and includes about 50 to 95% by weight of protein. A novel method of manufacture and packaging disclosed permits a consistent blending of the coarsely granulated mixture of cereal pieces with the finely granulated protein powder mixture in a compact package, while maintaining the larger granularity of the cereal mixture.

### CROSS REFERENCE TO RELATED APPLICATION

This application is a divisional of co-pending U.S. patent application Ser. No. 11/866,284 for “Packaged Protein-Enriched Food Product,” filed Oct. 2, 2007, which is hereby incorporated by reference, and claims priority and the benefit under 35 U.S.C. §120.

### FIELD OF THE INVENTION

The present invention relates to a protein-enriched food product having enhanced texture characteristics combined with ease of use. A method for its manufacture and packaging is disclosed.

### BACKGROUND

High protein food sources such as meat, fish, soy and dairy products, and legumes and the like have traditionally been used by nutritionists to establish consumption levels needed to meet the Recommended Daily Allowance (RDA) for protein in varied diets for adults and children. However, changing lifestyles of consumers have increasingly brought on the need to either lose weight or to gain weight by managing diet through more appropriate nutritional intake. Moreover, an increasing focus on the importance of exercise for good health has correspondingly generated an increase in interest in sports nutrition as a way to manage body health.

Managing body health through appropriate nutritional intake and exercise is accomplished by selective intake of metabolites such as protein, fat, carbohydrates, vitamins and minerals so that goals such as sustained energy availability for intense performance (such as running) or for maximizing muscle mass in bodybuilding goals are achieved.

Maximizing protein intake has been an accepted way for maximizing muscle mass in bodybuilding. A market has been established for products which maximize protein content while minimizing other essential metabolites without putting body health at risk. It has been known to use breakfast cereals as a vehicle to deliver more protein. Indeed, it has long been known to supplement the protein content of breakfast cereals to increase their overall protein content.

For example, the Schwab U.S. Pat. No. 3,873,748 describes a method to make a high protein (up to 25%) ready to eat flake breakfast cereal by cooking, extruding, drying and grinding a basic cereal matrix and then blending the resulting product with sodium caseinate, rewetting the mixture and extruding to form pellets, and finally using high pressure rolls to create the flakes. Likewise, the Malzahan U.S. Pat. No. 3,852,491 describes the use of high temperature/high pressure (HTHP) extrusion to produce an expanded cereal containing up to 55% protein.

More recently, natural whole grained cereal products enhanced with protein-enriched supplements have achieved a high degree of consumer acceptance. For example, hearty protein-enriched oatmeal and granola mixtures have found particular commercial success. However, problems have arisen with regard to the packaging such cereal mixtures.

In particular, it is difficult to maintain a consistent mixture of protein enriched supplements, typically in the form of fine granulated particles, with the relatively coarser whole grained cereal products during an automated packaging process. For example, when whole grained cereal pieces are combined with a finely granulated protein-enriched powder in a common mixing/distribution bin of an automated packaging system, the cereal pieces tend to separate from the powder during the course of the automated packaging process. Thus, while the first quantities of the mixture packaged may have a consistent blend of cereal pieces and protein-enriched powder, during the course of a production run the cereal pieces tend to rise to the top of the mixing/distribution bin resulting in an inconsistent, non-homogeneous blend of cereal pieces and protein-enriched powder being packaged.

A variety of proposals have previously been made to alleviate this problem. One prior art solution comprises combining the ingredient more vigorously in the mixing bin, so as to sustain a homogeneous mixture. However, this typically results in the cereal pieces being ground down into smaller pieces, which detracts from the commercial presentation of the mixture. Moreover, this solution detracts from the sensory qualities of the resulting mixture when prepared. Instead of a consistent hearty cereal mixture that maintains its original character, one is left with a homogenous mushy gruel. A need, therefore, exists for an improved process for packaging a protein-enriched food product having enhanced texture characteristics combined with ease of use.

### SUMMARY OF THE INVENTION

The present invention overcomes many of the disadvantages of prior art processes for packaging protein-enriched cereal mixtures. The novel method of manufacture and packaging disclosed permits a consistent blending of a coarsely granulated mixture of cereal pieces with a finely granulated protein powder mixture in a compact package, while maintaining the larger granularity of the cereal mixture.

The improved process includes an automated packaging system which includes separate distribution bins for dispensing coarsely granulated cereal pieces and finely granulated protein-enriched powder. The distribution bins may be arranged either in parallel or in series during the packaging process. During the packaging process, specific quantities of cereal pieces and protein-enriched powder are combined in each package, resulting in a more consistent packaged mixture throughout the packaging process. Moreover, the mechanisms for dispensing the cereal pieces and protein-enriched powder may each be designed to maximize dispensing efficiency while minimizing damage to the component parts of the mixture.

In one embodiment, the protein-enriched food product comprises a coarsely granulated mixture of cereal pieces combined with a finely granulated high-protein powder mixture. The cereal mixture has a moisture level between 2% and 20% by weight, and comprises a edible fiber material so that fiber content is between 2% and 20% by weight. The protein powder mixture has a moisture level between 2% and 20% by weight, and includes about 50 to 95% by weight of protein.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 is a perspective view of the inlet portion of an embodiment of the automated packaging system of the present invention.

FIG. 2 is an overhead or plan view of the front portion of the embodiment of the automated packaging system of the present invention shown in FIG. 1; and

FIG. 3 is a side view of the outlet portion of an embodiment of the automated packaging system of the present invention.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

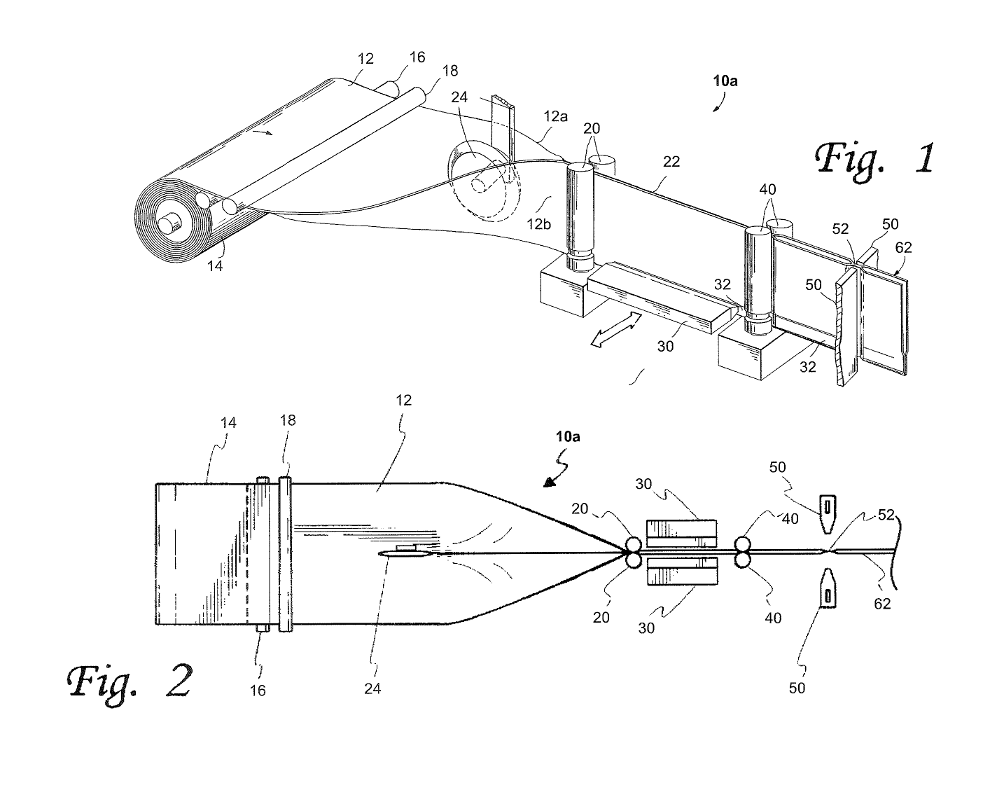

With reference to FIGS. 1 and 2, there is schematically illustrated an embodiment STOP of the inlet portion, generally designated by the reference number 10a, of the automated packaging system of the present invention. The automated packaging system comprises a form, fill and seal machine 10, wherein a sheet of packaging film 12 is formed into a web of individual horizontal pouches, which are subsequently filled with product, sealed and detached from the web. To this end, a sheet of packaging film 12 is supplied in a continuous stream to the machine 10 from a roll of film 14. The machine may include a guiding mechanism, schematically illustrated by a pair of rollers 16 and 18 which maintains the alignment position of the sheet 12 as the sheet 12 is fed into the machine 10.

It is understood that the sheet of packaging film 12 may comprise any one of an assortment of plastic, foil, paper, or composites thereof, which are currently available and known in the art of packaging technology. Moreover, the packaging film 12 may include graphical illustrations printed thereon. The sheet of film 12 is conveyed from the roll of film 14 into a pair of intake rollers 20. Prior to reaching the intake rollers 20, the horizontal film sheet 12 is folded into a vertical orientation so that the two longitudinal edges of the sheet are aligned substantially adjacent with one another. A roller mechanism 24 aids in smoothly transitioning the horizontal sheet into its vertical orientation. The horizontal film sheet 12 is, therefore, essentially folded in half along its longitudinal axis so as to form the two panels or sides 12a, 12b of the resulting pouches.

The folded, vertically oriented sheet of film 22 is then conveyed through a second pair of rollers 40, which, in conjunction with the intake rollers 20, apply a longitudinal tensile force to the vertically oriented film sheet 22 so as to ensure that the two adjacent halves of the sheet 12a, 12b remain smooth, taut and aligned. A horizontal sealing mechanism, such as heated sealing bars 30, positioned between the rollers 20, 40 impart a horizontal heat seal on the two adjacent sides near the fold in the film sheet. During a periodic pause in the machine 10, the heated sealing bars 30 reciprocate to form a continuous horizontal seal 32 in the two adjacent sides near the fold in the film sheet 22.

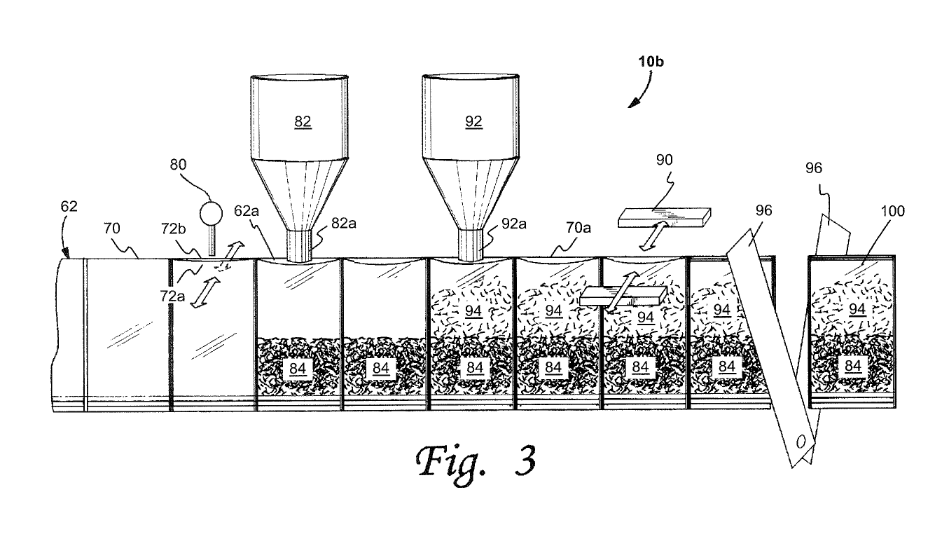

The folded, vertically oriented sheet of film 22 is further conveyed through the machine 10 to a vertical sealing mechanism, such as heated sealing bars 50, which imparts a vertical seal into the two adjacent sides of the film sheet. During a periodic pause in the machine 10, the heated sealing bars 50 reciprocate to form a vertical heat seal 52 in the two adjacent sides 12a, 12b of the vertically oriented sheet of film 22. The vertical seal 52 preferably extends across the entire vertical span of the vertically oriented sheet of film 22 including the previously formed horizontal seal 32. Thus, the sheet of packaging film 12 is transformed into a continuous web 62 of individual horizontal pouches, which are sealed on three sides. Following the formation of the vertical seals 52, the web of individual horizontal pouches 62 is advanced to the outlet portion 10b (FIG. 3) of the machine 10 for filling and cutting.

Referring now to FIG. 3, there is schematically illustrated an embodiment of the outlet portion, generally designated by the reference number 10b, of the automated packaging system of the present invention. As previously mentioned, the web of individual horizontal pouches 62 is advanced from the inlet portion 10a (see FIGS. 1 and 2) to the outlet portion 10b (see FIG. 3) of the machine for filling and cutting.

An unsealed end 70 of each pouch is opened preferably by a puffer device 80, which causes the two adjacent sides 72a, 72b of the individual pouch to separate from one another. In an alternate embodiment, the unsealed end 70 of each pouch is opened by opposing mechanical arms (not shown), which grasp and separate the two adjacent sides 72a, 72b of the individual pouch from one another. The mechanical arms grasp the pouch sides via conventional mechanical, electrostatic or suction means. The opened pouch 62a is then moved under a first distribution bin 82 having a filling spout 82a which dispenses a quantity of a high protein powder mixture 84 into the pouch 62a. The partially filled pouch is then moved under a second distribution bin 92 having a filling spout 92a where a specific quantity of the cereal mixture 94 is added to the pouch. The opened unsealed end 70a of each filled pouch is then sealed using a horizontal sealing mechanism, such as heated sealing bars 90 which engage and seal the end 70 of each bag.

The fully sealed pouches 100 are then separated from the web 62 by the cutting blades 96. 5 In an alternative embodiment, the first distribution bin 82 and filling spout 82a is utilized to dispense a quantity of the cereal mixture into each bag and the second distribution bin 92 and filling spout 92a is utilized to dispense a quantity of a high protein powder mixture 84 into each bag. In yet another alternative embodiment, the first and second filling spouts 82a, 92a are positioned in a side-by-side (i.e., parallel) arrangement relative to the translation of the web of individual horizontal pouches 62, so that a bag is simultaneously filled with a quantity of high protein powder mixture and a quantity of cereal mixture.

The high protein powder mixture may comprise a finely-granulated mixture of dehydrated protein powder having a moisture level between 2% and 20% by weight, and including 50 to about 95% by weight of protein. The dehydrated protein powder may be derived from milk, egg, soy, vegetables, grain or whey protein. In a preferred embodiment, the moisture level of said high protein powder mixture is between 2% and 8% by weight, and includes 50 to about 70% by weight of protein.

The cereal mixture is comprised of coarsely granulated whole or refined grain cereal pieces or flakes having a moisture level between 2% and 20% by weight, and includes a edible fiber material so that the fiber content is between 2% and 20% by weight. For example, the cereal mixture may comprise an oatmeal mixture (i.e., whole oats, oat bran, steel-cut oats, rolled oats, quick oats, or instant oats), or flakes comprised of oats, corn, rice, wheat, millet, barley or rye, or assorted blends thereof. The cereal mixture may further comprise fruit and/or nut pieces in a granola or muesli type mixture. In a preferred embodiment, the fiber content of the cereal mixture is greater than 10% by weight, and has a particle size distribution such that from 50% to about 100% remain on a #8 U.S. screen. In a preferred embodiment, the amount of protein in the cereal mixture is from at least about 10 grams to about 24 grams per 1 ounce and the amount of fiber material is about 1 gram to about 5.5 grams per 1 ounce. The particle size of the cereal mixture of the present invention is increased such that from 60% to about 100% remain on a #8 U.S. screen. Particle size distribution is a measure of the granularity of the cereal mixture. It is generally a weight-based distribution of the mixture based on the size of particles. Normally, it is described by a set of U.S. standard measure sizes. Increasing the size of the cereal mixture such that there are fewer fines can change the physical properties of the resulting mixture.

As noted previously, the two filling spouts 82a, 92a may each disperse either a high protein powder mixture or a cereal mixture into the opened pouch as it passes by. While the high protein powder mixture is a finely granulated mixture, the mixture of cereal pieces is a comparatively coarsely granulated mixture. Thus, the two filling spouts 82a, 92a may each include a dispensing mechanism, which may be modified to disperse its contents in the most efficient yet least destructive method depending upon the granularity, moisture content, and fragility of a particular mixture. For example, the dispensing mechanism may comprise an auger-type filler, a free-flow auger type, a net weight scale type filler or a bucket/volumetric-type filler. By dispersing the high protein powder mixture and mixture of cereal pieces separately, the consistency of the resulting mixture is reliably maintained throughout a production run. Moreover, damage to the component parts of each mixture may be minimized during the packaging process.

It will now be evident to those skilled in the art that there has been described herein an improved process for manufacturing and packaging a consistent blending of a coarsely granulated mixture of cereal pieces with a finely granulated protein powder mixture in a compact package, while maintaining the larger granularity of the cereal mixture.

Although the invention hereof has been described by way of a preferred embodiment, it will be evident that other adaptations and modifications can be employed without departing from the spirit and scope thereof. For example, the process is readily adapted to use in other automated packaging systems, such as automated cup filler devices. Moreover, the process may be used to manufacture and package other protein enriched foods comprised of a blend of coarsely granulated pieces with a finely granulated protein powder mixture. For example, coarsely granulated pasta pieces may be consistently blended and packaged with a finely granulated protein powder mixture without damaging the shape of the pasta pieces. The terms and expressions employed herein have been used as terms of description and not of limitation; and thus, there is no intent of excluding equivalents, but on the contrary it is intended to cover any and all equivalents that may be employed without departing from the spirit and scope of the invention.

We claim:

1. A method of making a packaged protein-enriched cereal mix comprising the steps of:
(a) preparing a protein powder mixture having a moisture level between 2% and 15% by weight, and including 50 to about 95% by weight of protein;
(b) preparing a cereal mixture having a moisture level between 2% and 20% by weight, and including a edible soluble fiber material so that soluble fiber content is between 2% and 20% by weight, and having a particle size distribution such that from 50% to 60% remain on a #8 U.S. screen;
(c) mixing said products of steps (a) and (b) in a heat seal pouch;
wherein said mixing step includes dispensing said high protein powder into said heat seal pouch after placing said cereal mixture into said heat seal pouch, and
wherein the amount of said protein in said cereal mixture is from at least about 10 grams to about 24 grams per 1 ounce and the amount of fiber material is about 1 gram to about 5.5 grams per 1 ounce.

2. The method of claim 1, wherein said protein powder is comprised of milk protein.

3. The method of claim 1, wherein said protein powder mixture is comprised of egg protein.

4. The method of claim 1, wherein said protein powder mixture is comprised of soy protein.

5. The method of claim 1, wherein said protein powder mixture is comprised of vegetable protein.

6. The method of claim 1, wherein said protein powder mixture is comprised of grain protein.

7. The method of claim 1, wherein said high protein powder mixture is comprised of whey protein.

8. The method of claim 1, wherein said cereal mixture furthers comprised of whole grain cereal pieces.

9. The method of claim 1, wherein said cereal mixture is comprised of whole grain cereal flakes.

10. The method of claim 1, wherein said cereal mixture is comprised of a refined grain cereal pieces.

11. The method of claim 1, wherein said cereal mixture is comprised of refined cereal grain flakes.

12. The method of claim 1, wherein said cereal mixture further comprises fruit pieces.

13. The method of claim 1, wherein said cereal mixture further comprises nut pieces.

14. The method of claim 1, wherein the moisture level of said protein powder mixture is between 2% and 12% by weight, and includes 60 to about 85% by weight of protein.

15. The method of claim 1, wherein the moisture level of said cereal mixture is between 2% and 15% by weight.

16. The method of claim 1, wherein the fiber content of said cereal mixture is greater than 10% by weight, and has a particle size distribution such that from 60% to about 100% remain on a #8 U.S. screen.
